(19) United States
(12) Patent Application Publication
(10) Pub. No.: US 2019/0357324 A1
(43) Pub. Date: Nov. 21, 2019

(54) Universal Electronic Oven Heating Functionality Module

(71) Applicant: The Markov Corporation, Dover, DE (US)

(72) Inventors: Roger Sharpe, Mountain View, CA (US); Nick C. Leindecker, Portola Valley, CA (US); Leonard Robert Speiser, Los Altos, CA (US)

(73) Assignee: The Markov Corporation, Dover, DE (US)

(21) Appl. No.: 16/243,586

(22) Filed: Jan. 9, 2019

Related U.S. Application Data
(60) Provisional application No. 62/673,909, filed on May 19, 2018.

(51) Int. Cl. H05B 6/76; H05B 6/64

(52) U.S. Cl. CPC H05B 6/763; H05B 6/6426

(57) ABSTRACT

Universal electronic oven heating functionality modules and associated methods are disclosed herein. One such module includes an energy steering element, a controller with control logic for the energy steering element, a first means for forming a seal with an opening, and a casing to enclose the controller and the energy steering element. The casing can include top and bottom side elements. One such method includes providing a functionality module with a mounting plate, the first means for forming a seal, and the casing. The method also includes providing an electronic oven with a heating chamber and a second means for forming a seal with the functionality module. The heating chamber can have a first opening for a heating chamber door, and a second opening for functionality module reception. The method also includes engaging the functionality module with the heating chamber to form a seal between the first and second means.

### CROSS REFERENCE TO RELATED APPLICATIONS

This application claims priority to U.S. Provisional Application No. 62/673,909, filed May 19, 2018, which is incorporated by reference herein in its entirety for all purposes.

### BACKGROUND

Electronic ovens are a globally utilized tool to heat items as they provide a wide array of conveniences for the user, including ease of installation, high safety standards, and compatibility with both local and regional energy sources. In industrial and research settings, electronic ovens can be designed to have specific qualities, such as the ability to produce high power output, extremely localized heating, and expedited ramp up and cool down. Electronic ovens can also be designed for use as a common household appliance, such as for heating food items with low power, acceptable heating uniformity, and convenient heating time. The transferability of a device or a design improvement from one electronic oven application to another is one of the factors that reinforces the ubiquity of electronic ovens.

The manufacture of the entire ecosystem of electronic oven designs, however, is not without significant challenges. Devices produced for mature markets, such as electronic ovens, will often use different generations of technology to realize a fully optimized design, creating manufacturing and supply-chain logistics mismatches that may require additional resources to streamline. Furthermore, the critical process of gaining and retaining market share in the global economy requires constant innovation and growth into increasingly niche markets, counterposed by the cost-reduction benefits of streamlining manufacturing processes and standardizing parts and components. Consequently, development of novel electronic oven technology continues to provide value.

### SUMMARY

A universal electronic oven heating functionality module and associated methods are disclosed herein. The functionality module can assist with the implementation of a heating process with greater efficiency, lower cost, higher quality results, and enhanced safety of operation as compared to other electronic ovens. The functionality module can be used with any electronic oven including electronic ovens designed specifically for use with the functionality module, or an electronic oven that has been augmented to be retrofitted with the functionality module. The module can indeed be used to augment any heating system including a conventional radiative heat oven or an industrial heating system. The functionality module can include complex control systems including those that utilize machine intelligence, energy steering elements, and sensors that can greatly improve the performance of a standard electronic oven. The functionality module can also include an energy source, such as a magnetron, and be configured to receive power from an electronic oven to which it is attached or from a separate external connection. However, not all these features need to be included in the functionality module to be in accordance with this disclosure, as subsets of the above features can be left out or provided by the remainder of the electronic oven.

Heating functionality modules in accordance with this disclosure provide certain benefits. For example, the heating functionality module can be manufactured in a different location and manufacturing environment than the electronic oven itself such that if the electronic oven manufacturing environment requires lower tolerances, and accordingly cheaper manufacturing methods, a multi-part, integrated unit can be produced for a lower cost than a monolithic unit with equivalent functionality. As another example, a single functionality module that includes a technology company's core technology platform can be used to augment a wide variety of electronic ovens offered by any number of companies such that it provides an efficient vehicle for provisioning and controlling the core technology platform of the technology company.

### BRIEF DESCRIPTION OF THE DRAWINGS

FIG. 1 provides computer aided design images of a heating functionality module assembly in an exploded-view, and an electronic oven in an isometric view, in accordance with specific embodiments of the present invention.

FIG. 2 provides a block diagram and flow chart demonstrating a set of methods for attaching a heating functionality module to an electronic oven in accordance with specific embodiments of the present invention.

FIG. 3 provides a computer aided design image in an isometric view of an assembly of an electronic oven mated with a heating functionality module in accordance with specific embodiments of the present invention.

FIG. 4 provides a block diagram and flow chart demonstrating a set of methods that can modify the configuration of an electronic oven heating chamber, originally prefabricated for “stand alone” operation, to receive and to function with a heating functionality module in accordance with specific embodiments of the present invention.

FIG. 5 provides computer aided design images, with isometric and profile views, of electromagnetic interference spring fingers attached to the module reception opening on an electronic oven heating chamber in accordance with specific embodiments of the present invention.

FIG. 6 provides a computer aided design image in an isometric view of an electronic oven heating chamber with a module reception opening that comprises a four-edged module reception opening perimeter in accordance with specific embodiments of the present invention.

FIG. 7 provides a computer aided design image in isometric view of an electronic oven heating chamber with attached heating functionality module in accordance with specific embodiments of the present invention.

FIG. 8 provides two line drawings of the inside of a prototype electronic oven heating chamber with attached heating functionality module showing configurations of an integrated splashguard and sensor apertures in accordance with specific embodiments of the present invention.

FIG. 9 provides computer aided design images in isometric views of a heating functionality module and a heating functionality module mated with an electronic oven in accordance with specific embodiments of the present invention.

FIG. 10 provides a computer aided design image in an isometric view of a heating functionality module with a casing top side element in accordance with specific embodiments of the present invention.

FIG. 11 provides two line drawings of the inside of a prototype electronic oven heating chamber with attached heating functionality module in accordance with specific embodiments of the present invention.

FIG. 12 provides a block diagram and flow chart demonstrating a set of methods to assemble a heating functionality module in accordance with specific embodiments of the present invention.

FIG. 13 provides a computer aided design image in an isometric view of a corner portion of the heating functionality module related to one example attachment of the casing to the mounting plate in accordance with specific embodiments of the present invention.

### DETAILED DESCRIPTION

Methods and systems disclosed herein include an electronic oven and a universal electronic oven heating functionality module. Electronic ovens can heat items in a heating chamber using an electric energy generator by transferring energy from the generator to the items. One example of an electronic oven is a microwave oven that uses a radio frequency (RF) radiation generator, such as a magnetron, to create electromagnetic (EM) energy for heating. Heating is accomplished by absorption of the EM energy by the item. Methods and systems disclosed herein relate to a functionality module and an electronic oven designed for use with the functionality module, as well as an augmented electronic oven that can be retrofitted with the functionality module. The functionality module can be a heating functionality module that can assist in implementing a heating process for greater efficiency, lower cost, higher quality results, and enhanced safety of operation, as compared to other electronic ovens.

A heating functionality module in accordance with this disclosure can include a variety of components that provide unique utility to an electronic oven. The module can include one or more of a control system, a sensing system, and an energy steering system for the electronic oven. The control system can include an integrated circuit or chip set storing instructions to implement a heating process. The sensing system can include one or more sensors, including sensors of differing types, such as infrared, visible light, auditory, humidity, thermal, radio frequency energy, and other electronic oven sensor types. The energy steering system can include one or more antennas and variable reflectance elements, including sets of variable reflectance elements. The energy steering system can include mechanically actuated elements such as a conventional mode stirrer and an array of movable variable reflectance elements. The energy steering system can include mechanically fixed elements, including a set of variable reflectance elements that can be an array of fixed location beam steering antennas.

The heating functionality module can include one, or a combination, of control elements, sensing elements, and energy steering elements to provide functionality to an electronic oven. In a first example, the heating functionality module can reduce the amount of energy required by the electronic oven to implement a heating process by using energy steering elements that distribute the heating energy in a more efficient manner. In a second example, the heating functionality module can produce a higher quality produce by enhancing the item heating profile uniformity through the implementation of energy steering elements. In a third example, the heating functionality module can detect the temperature of a heated item using a controller processor controlled IR sensor to inform a closed-loop feedback algorithm that can control the heating process with greater fidelity. In a forth example, the heating functionality module can identify the item to be heated using a controller processor controlled sensor to queue a pre-optimized heating method corresponding to the identified item. In a fifth example, the functionality module can include a computer-readable medium that stores instructions to instantiate a machine intelligence system. The machine intelligence system can include support elements such as artificial neural networks, support vector machines, and function approximators. The machine intelligence system can include a classifier used to identify items detected by sensors of the electronic oven. The machine intelligence system can include support elements such as reinforcement learning systems and deterministic planners to control the energy steering elements and obtain training data from the sensors.

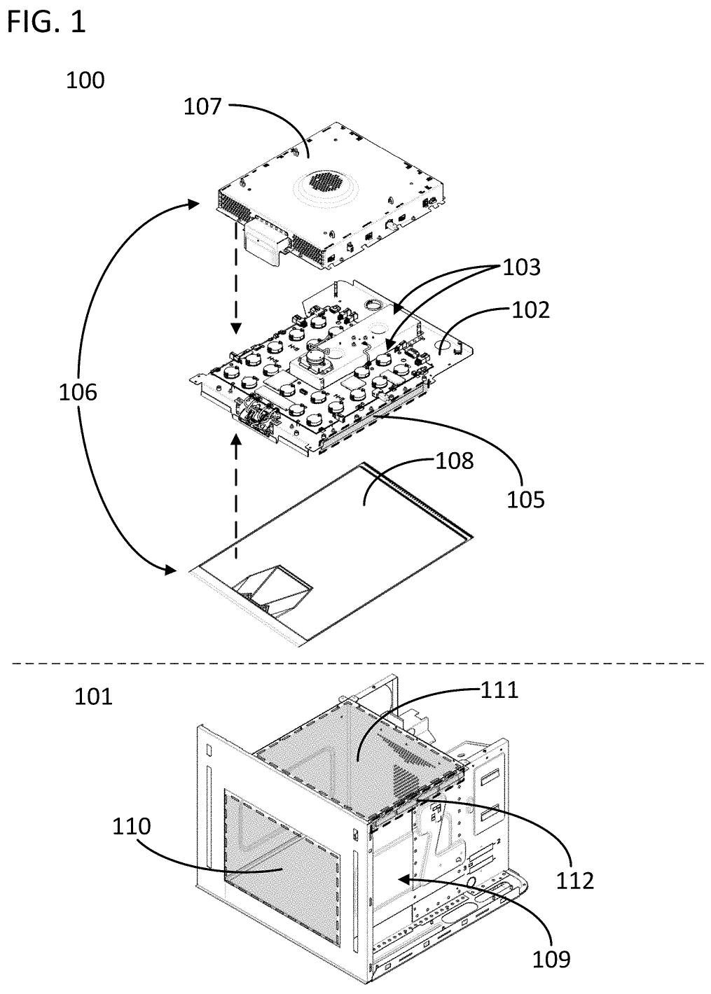

FIG. 1 provides computer aided design images of a heating functionality module 100 assembly, and an electronic oven 101, in accordance with some of the approaches disclosed herein. The heating functionality module 100 has a mounting plate 102, and top side components 103 that are placed above the mounting plate 102, and bottom side components that are placed below the mounting plate 102. The mounting plate 102 can ultimately be used to form part of an EM barrier that defines the heating chamber 109. As such, bottom side components can be components that are intended for placement in the heating chamber 109, while top side components 103 are components that should be kept out of the heating chamber 109. In one example, top side components 103 can be electrical computing components installed on a substrate, such as a Printed Circuit Board (PCB). In the same example, the electrical computing components can include installed memory and processors to perform functions as a controller for the electronic oven 101. In one example, the top side components 103 can include a waveguide and RF energy source, such as a magnetron, for generating and directing RF energy into the heating chamber 109 of the electronic oven 101. In another example, the top side components 103 can include a direct ported RF energy source without a waveguide. In one example, the bottom side components can be energy steering elements actuated by electro-mechanical actuators.

In some embodiments, the heating functionality module 100 can be configured to engage with an electronic oven 101 and form a seal therewith. In one example, the seal can be an RF radiation opaque seal. In these embodiments, the heating functionality module 100 can have a first means for forming a seal 105 configured to form the seal with a second means for forming a seal 112 on the electronic oven 101, in which the seal can provide mechanical attachment and the prevention of RF energy leakage from within the heating chamber 109 to the outside. In some embodiments, the seal can be formed between the mounting plate 102 and the electronic oven 101 such that the mounting plate 102 forms a surface of the heating chamber 109 of the electronic oven 101.

In some embodiments, the heating functionality module 100 can have a casing 106 attached thereon, comprising a top side element 107 and a bottom side element 108, both of which can be fastened to the mounting plate 102. In these embodiments, the top side components 103 can be placed on heating functionality module 100 above the mounting plate 102 and below the casing top side element 107. In a pseudo-mirrored fashion about the plane of the mounting plate 102, the bottom side components can be placed on heating functionality module 100 below the mounting plate 102 and above the casing bottom side element 108. In one example, the casing 106 can help prevent mechanical shock to the relatively delicate top side components 103 and bottom side components through the stages of the module's lifetime, including manufacturing, handling, shipping, installing, retrofitting, and in the end-use application.

In some embodiments, the bottom side element 108 can contain a portion that is transparent to RF radiation to allow for the transmission of EM energy from the heating functionality module 100 to the heating chamber 109 when the heating functionality module 100 is attached to the electronic oven 101. The casing bottom side element 108 can be a false wall of the heating chamber 109 by being configured to be conformal to the perimeter of the heating chamber 109 and sealed thereon. The false wall can then protect the bottom side components from mechanical shock or splatter from within the heating chamber 109 while still allowing EM energy to be delivered from the module to the electronic oven 101. Likewise, bottom side components comprising energy steering elements can still interact with the electric field in the heating chamber 109 even though they are located behind the false wall. The false wall can also be opaque to visible light to hide the bottom side components from view. The false wall can also be translucent to visible light in order which could provide an amusing user experience in situations where the energy steering elements included movable components.

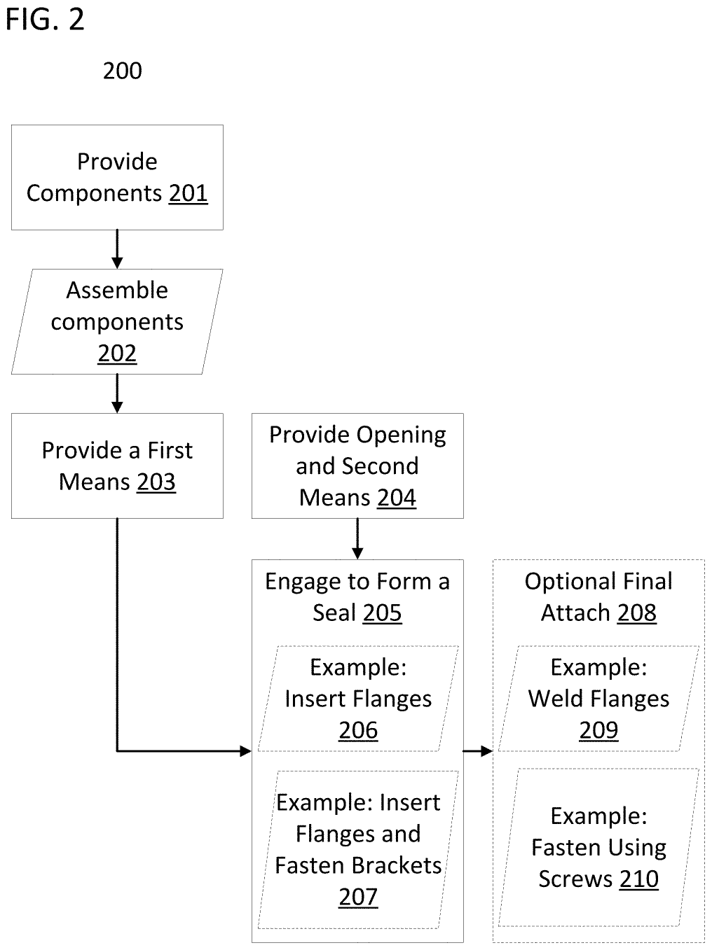

FIG. 1 includes an illustration of a stripped-down version of an electronic oven 101, in which the electronic oven 101 visually represented in FIG. 1 is shown only with a few of the basic components that are included in the whole. In some embodiments, the electronic oven 101 can be designed and manufactured to be assembled with the heating functionality module 100 or it can be retrofitted to operate with heating functionality module 100 after the electronic oven 101 manufacture has been completed. The electronic oven 101 can have a heating chamber 109 with a first opening for a heating chamber door 110 configured for the attachment of any type of door, including sliding doors or swing-out doors. Additionally, the electronic oven 101 can have a second opening for functionality module reception 111 that can be configured for the fitting of a heating functionality module 100. In one example, the second opening for functionality module reception 111 can include a second means for forming a seal 112 configured to engage with the first means for forming a seal 105. Specific examples of the means for forming a seal and the types of seals formed thereby are provided below, especially as described with respect to the set of methods illustrated in FIG. 2.

FIG. 2 provides a block diagram and flow chart demonstrating a set of methods 200 for attaching a heating functionality module to an electronic oven that are in accordance with some of the appraoches disclosed herein. In some embodiments, the set of methods 200 can begin by providing the heating functionality module components 201, which can include a casing, a mounting plate, top side components, and bottom side components. In one example, the casing can be a stiff material such as a plastic, such as polypropylene or polyvinyl chloride, or a metal, such as steel or aluminum. In one example, the module can also include a first means for forming a seal, which could be placed on the mounting plate. In one example, the mounting plate can be a machined or fabricated metal piece that has at least one portion with an exposed surface to be in electrically conductive contact with a portion of the first means for forming a seal. The first means for forming a seal can include flanges or brackets extending outward from the mounting plate. The flanges or brackets can be bent or punched from a sheet of material that forms the mounting plate, or they can be separately fabricated and adhered to the mounting place via welding or any other process.

In some embodiments, the set of methods 200 can include the assembling of the heating functionality module components 202 to form the heating functionality module. In one example, the assembly can be performed by fastening the top side components and bottom side components to the mounting plate on the top side and bottom side, respectively. In an example next step in the assembling process 202 the heating functionality module components can be assembled. The casing top side element and casing bottom side element can be fastened to the mounting plate on the top side above the top side components and on the bottom side below the bottom side components, respectively.

In some embodiments, the assembled heating functionality module can be provided with a first means for forming a seal 203 attached thereon. Meanwhile, an electronic oven heating chamber can be provided with an opening for functionality module reception and a second means for forming a seal 204 attached on the electronic oven. In the same embodiments, following the provisioning in steps 203 and 204, the first means for forming a seal and the second means for forming a seal can be engaged to form a seal 205 after the heating functionality module has been fitted to the opening for functionality module reception on the electronic oven heating chamber. For example, the first means for forming a seal can be a set of flanges that project outward from the mounting plate and the second means for forming a seal can be a set of electromagnetic interference (EMI) spring fingers, wherein the seal can be formed by the insertion of the flanges into the EMI spring fingers 206. In another example, the mounting plate can have four edges wherein the first means for forming a seal can include a set of brackets configured to be attached with mechanical fastening feature on two opposing edges and flanges on the remaining two opposing edges, and the second means for forming a seal can include two sets of brackets with configured to be attached with the mechanical fastening feature and two sets of EMI spring fingers. The mechanical fastening features can be aligned holes for receiving screws or rivets, or mechanical clamps. In the same example, the seal can be formed by the alignment of the flanges and brackets for the first means to EMI spring fingers and brackets for the second means, respectively, with the fastening of the brackets by the drilling of screws, tightening of rivets, application of clamps, or other fastening action of a mechanical fastening feature and the insertion of the flanges into the EMI spring fingers 207.

In some embodiments, an optional final attach method step 208 can be performed after the seal has been formed 205. In one example, the optional final attach method step 208 can be the spot welding of the flanges 209, after having been inserted into the EMI spring fingers, to the electronic oven heating chamber body. In another example, the optional final attach method step 208 can be the fastening of the edges and corners of the heating functionality module to the electronic oven using eight of fewer screws 210. The number of screws is a function of the length of the seal area needed to be ensured by the screws. In specific embodiments of the invention, the distance between screws is less than 30 millimeters along the path of the seal.

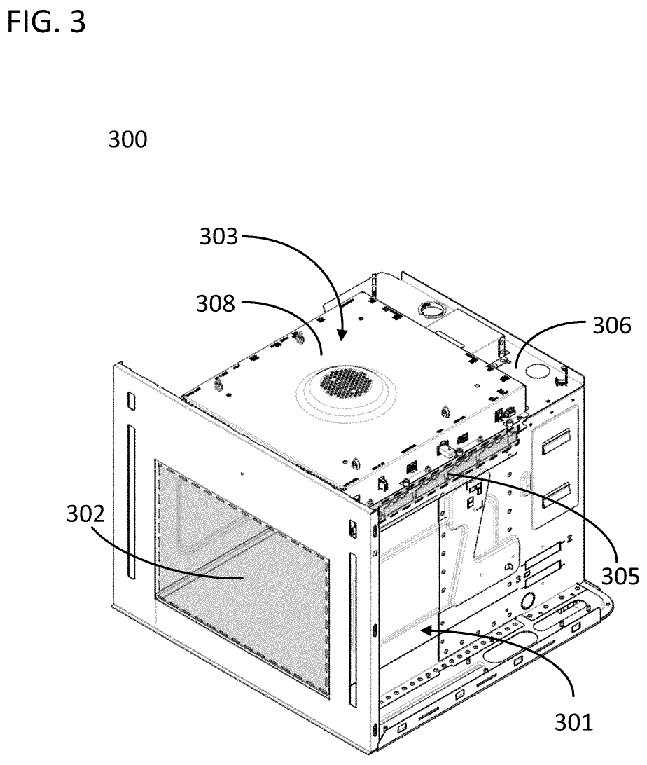

FIG. 3 provides a computer aided design image of an assembly 300 of a stripped-down electronic oven mated with a heating functionality module 303 in accordance with some of the approaches disclosed herein. In some embodiments, the electronic oven can have a heating chamber 301 and a first opening for a heating chamber door 302. In some embodiments, the first means for forming a seal on the heating functionality module 303 can be engaged with the second means for a seal on the electronic oven, to form a seal 305. The heating functionality module mounting plate 306, top side components, and casing top side element 308 can reside on the outside of the heating chamber 301, while the bottom side components and the casing bottom side element can reside inside the heating chamber 301.

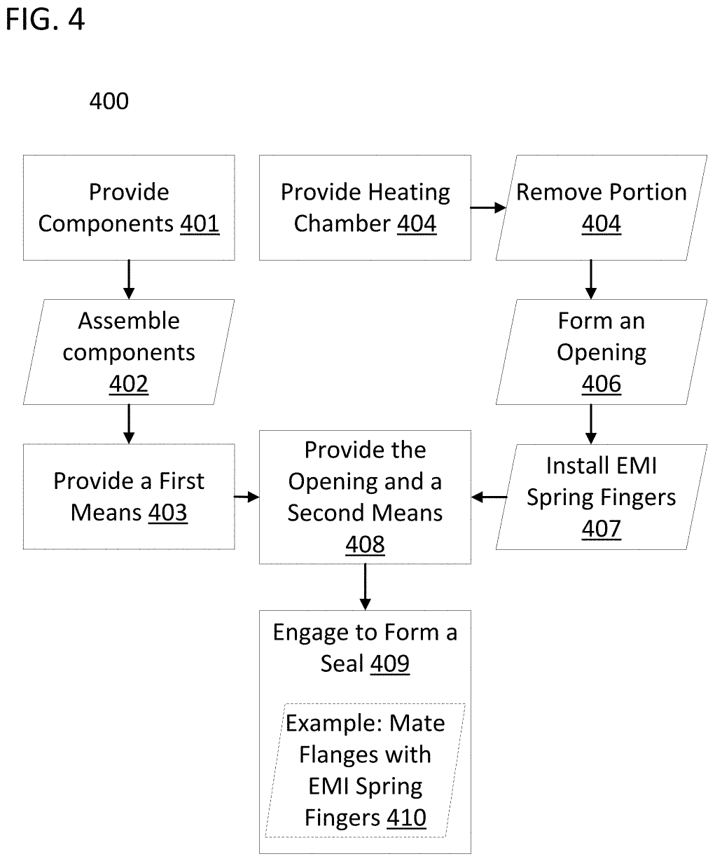

FIG. 4 provides a block diagram and flow chart demonstrating a set of methods 400 that can modify the configuration of an electronic oven heating chamber, originally prefabricated for “stand alone” operation, to receive and to function with a heating functionality module that is in accordance with some of the appraoches disclosed herein. In some embodiments, the heating functionality module components can be provided 401. Subsequently, the components can be assembled 402 to form the heating functionality module. After assembly, the heating functionality module can be provided with a first means for forming a seal 403. In the same set of methods 400, in parallel, an electronic oven heating chamber can be provided 404. In proceeding with the retrofit, a portion of the electronic oven heating chamber wall can be removed 405 and, in the place of the removed area, an opening for module reception with an exposed edge can be formed 406. The electronic oven heating chamber wall can be removed by cutting, punching, or other metal augmentation methods. A set of EMI spring fingers can be installed on the exposed edge of the opening 407. At the partial completion of the set of methods 400, through method steps 401 to 403 and 404 to 407, the augmented electronic oven heating chamber with the functionality module reception opening, as well as the second means for forming a seal, can be provided 408 for future engagement. Accordingly, the first means for forming a seal and the second means for forming a seal can be engaged to form a seal 409 between the heating functionality module and the electronic oven heating chamber. In one example, the engaging 409 can be accomplished by mating outwardly projecting flanges on a mounting plate of the heating functionality module, as the first means for forming a seal, with EMI spring fingers on the heating chamber, as the second means for forming a seal, 410.

In accordance with some of the approaches disclosed herein, the formed seal exhibits particular properties. In a first example, the seal can form a negligible resistance, electrical conduction path between the electrically conductive portion of the mounting plate on the heating functionality module and the electronic oven heating chamber walls. In other words, the electrical conduction path enables the shielding of the area outside the heating chamber from RF radiation by acting as an electrical short to a ground-node for shunting the electrical power equivalent to RF energy used for heating an item in an electronic microwave oven. In a second example, the seal can include having EM energy-opaque gaps along its structure, wherein the gaps' widths are smaller than a critical dimension to prevent energy leakage through the gap. In the second example, the air gap present along the seal can have a width no larger than one quarter of the wavelength of the RF radiation used for heating an item in an electronic microwave oven, which can be thirty millimeters. In a third example, the seal can have sufficient mechanical strength to permanently contact the heating functionality module to the electronic oven heating chamber under manufacturing, shipping, handling, and end-use conditions.

The first means for forming a seal and the second means for forming a seal can share seal-forming properties. In a first example, the seal-forming properties can include having the configuration of the first means for forming a seal contingent upon the configuration of the second means for forming a seal such that they can be engaged to form a seal. In a second example, the seal-forming properties can include having the configuration of the first means for forming a seal contingent upon the configuration of the second means of forming a seal such that, when engaged to form the seal, the seal has the electrical and mechanical properties as described above. In a third example, the seal-forming properties can include having the configurations of the first means for forming a seal and the second means for forming a seal be interchangeable. For example, the first and second means could interchangeably be EMI spring fingers while the other means includes flanges for insertion into the EMI spring fingers. In a fourth example, the seal-forming properties can include the first means for forming a seal and the second means for forming a seal that comprise sets of components that are attached to the heating functionality module and electronic oven heating chamber, respectively.

In some embodiments, the first means for forming a seal can include a member set configuration and the second means for forming a seal can include a sleeve set configuration, where the engaging to form a seal can be accomplished by the insertion of the member set into the sleeve set. A member set can be a set comprising posts, rods, cylinders, cones, or flanges. A sleeve set can be a set comprising cylindrical sleeves, standoffs, latches, clips, or spring fingers. Member sets and sleeve sets can engage by fastening mechanisms that are automatic or manual, such as interlocking threads or grooves, pressure locks, locking pins, glue, or a welded joint. In some embodiments, the first means for forming a seal can include a first bracket set configuration and the second means for forming a seal can include a second bracket set configuration, wherein the engaging to form a seal can be accomplished by the alignment and fastening of brackets in the first bracket set and the second bracket set. In one example, fastening can be accomplished by clamping, welding, gluing, or soldering the bracket sets. In another example, fastening can be accomplished with the incorporation of aligned holes, threaded or unthreaded, in the bracket sets, and by inserting components into the holes that provide a fastening force, such as bolts with fastening nuts, rivets, screws, locking bolts, or studs.

In some embodiments, the first means for forming a seal can include an overlapping fastener configuration and the second means for forming a seal can include a reception fastener configuration, where the engaging to form a seal is accomplished by the fastening of the overlapping fastener to the reception fastener, when they overlap. In one example, fastening can be accomplished by clamping, welding, gluing, or soldering. In another example, fastening can be accomplished with the incorporation of aligned holes, threaded or unthreaded, in the overlapping fastener and reception fastener, by inserting components into the holes that provide a fastening force, such as bolts with fastening nuts, rivets, screws, locking bolts, or studs.

The specific examples of first and second means for providing a seal as disclosed herein can be interchangeably connected to the functionality module or the electronic oven so long as the two elements that will form the seal each include a means for forming a seal. For example, the EMI spring fingers mentioned above can be welded to the functionality module and can form a seal with an exposed sheet metal edge of the electronic oven. In this example, the EMI spring fingers form the first means for forming a seal while the exposed sheet metal edge of the electronic oven, which will be inserted into the spring fingers, serves as the second means for forming a seal.

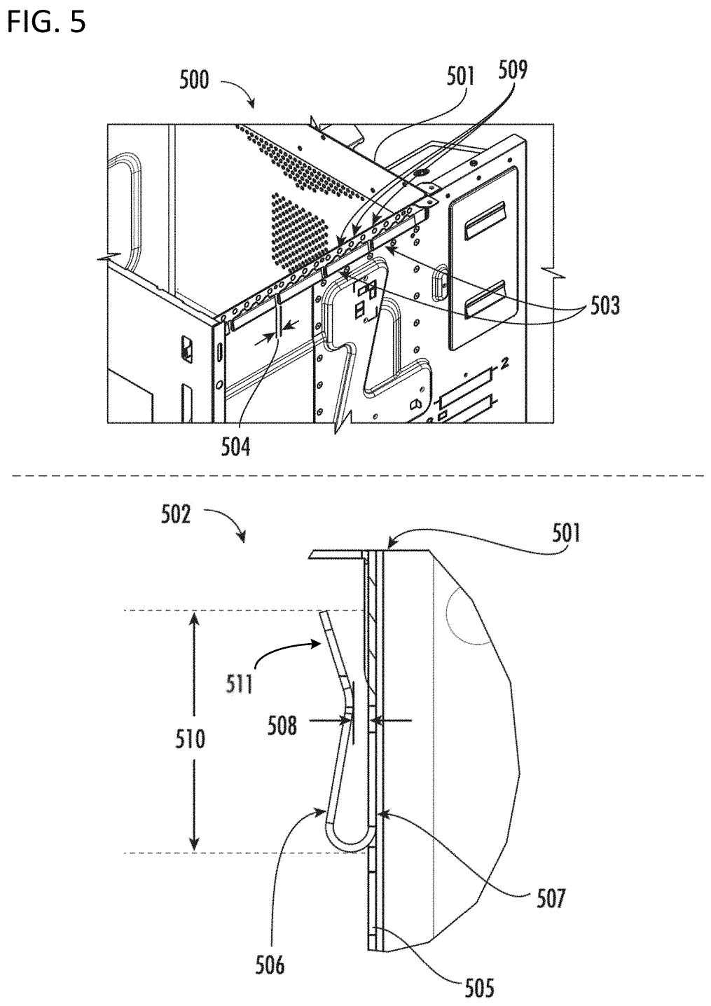

FIG. 5 provides computer aided design images, with isometric and profile views, of an electronic oven configured with EMI spring fingers 500 and a single EMI spring finger attached to an electronic oven heating chamber wall 502, in accordance with some of the appraoches disclosed herein. One example configuration of EMI spring fingers is exemplified in system 500 in FIG. 5, where EMI spring fingers can be used as a second means for forming a seal while attached to an edge 501 of the perimeter of the module reception opening on an electronic oven heating chamber. A single EMI spring finger 502 has a length measured along the direction of the module reception opening perimeter to which it is attached. In one example, a single EMI spring finger 502 can have a length of 56 millimeters. Single EMI spring fingers 502 used in sets of at least two EMI spring fingers 503 can be equidistant from each other by an EMI spring finger spacing 504. Portions of an EMI spring finger 502, in reference to their relative distance from the attached surface, such as an electronic oven heating chamber wall 505, comprise a distal EMI spring finger jaw 506 farther from the wall, and a proximal EMI spring finger jaw 507 closer to the wall. The two EMI spring finger jaws can be configured to not be parallel to each other or not to be completely planar in form. In one example, the distal EMI spring finger jaw 506 can have a single crimp parallel to the length of the EMI spring finger 502 such that when a member is inserted between the two EMI spring finger jaws, such as a flange, the distal EMI spring finger jaw 506 crimped portion can apply inward pressure along the flange to hold it in place. In the same example, the flange inserted into a set of EMI spring fingers 503 is thicker than the EMI spring finger gap 508 to induce at least a greater-than-zero pressure as applied by the EMI spring finger 502 to hold the flange in place. In addition to providing a mechanical contact, the applied pressure can also provide a ground path from the flange to the EMI spring finger. In the same example, an unloaded EMI spring finger gap 508 is optimal at 1.6 millimeters, and a loaded EMI spring finger gap 508 is optimal at 2.7 millimeters. In another example, the EMI spring finger gap 508 is no greater than 4 millimeters at any time during installation and use. The EMI spring finger gap 508 design simultaneously aims to avoid both too little clamping pressure that would lead to a defective seal, and EMI spring finger plastic deformation from inserting a flange where, for example, the EMI spring finger gap 508 is much smaller than the flange thickness.

In some approaches, the forming of a seal with a first means to form a seal and a second means to form a seal can have configuration constraints dependent on both the time and monetary economics of the forming of a seal. Sets of EMI spring fingers 503 can be chosen as the second means for forming a seal to be engaged with outward projecting flanges as the first means for forming a seal to enhance the installation speed and reduce the cost of heating functionality module to electronic oven attachment process, in comparison to other means such as aligned brackets fastened with screw holes by screws, due to the reduction of the number of parts, and time-cost reduction thereof.

In some approaches, the distal jaw pieces 506 in a set of EMI spring fingers 503 can have configuration constraints dependent on the user ergonomics of the forming of a seal. The outward angle of the top of the distal jaw 506 created by the crimp 511 can serve as a lead-in for a flange, making it easier to assemble the components. In addition, the outward angle of the top of the distal jaw 506 created by the crimp 511 can serve as a lever for a user to pull on and away from the heating chamber, temporarily increasing the EMI spring finger gap 508 and thus improving the ability to slide a member, such as a flange, into the set of EMI spring fingers 503. In one example, fabricating smaller sets of EMI spring fingers 503, rather than a long, single EMI spring finger 502, limits the total force required to pull on the distal jaw 506 as the required pulling force is proportional to the length of the EMI spring finger 502.

In some approaches, the distal jaw pieces 506 in a set of EMI spring fingers 503 can have configuration constraints dependent on the use of spot welding being used in a final attach process. In the sets of EMI spring fingers 503, the flange that can be inserted into the EMI spring fingers can be welded to the proximal EMI spring finger jaw 507 at spot weld locations 509. To facilitate access at the spot weld locations 509, the height of the distal EMI spring finger jaw 510 can be locally adjusted in the designing, manufacturing, or retrofitting processes.

In some approaches, the sets of EMI spring fingers 503 can have configuration constraints dependent on the requirements to make the formed seal opaque to RF radiation. RF radiation can leak through air gaps between electrically conductive materials if the gaps are larger than one quarter of the radiation wavelength, as described above, with the EMI spring finger spacing 504 being one such possible leakage area. Accordingly, the EMI spring finger spacing 504 can be less than thirty millimeters. In the one example, the EMI spring finger spacing 504 can be six millimeters. Another possible leakage area can be small air gaps due to irregularities in the engaging of a flange with sets of EMI spring fingers 503, where the leakage path would follow first between the flange base and the heating chamber edge 501, next through a gap between the flange and the proximal EMI spring finger jaw 507, and finally between the flange and the distal EMI spring finger jaw 506. This leakage path is made tortuous by the particular shape of the sets of EMI spring fingers 503 and the distal EMI spring finger jaw height 510, and therefore minimizes the total amount of leakage. In one example, the distal EMI spring finger jaw height 510, and equivalently the EMI spring finger channel height, is greater than ten millimeters.

In some approaches, planar sets of EMI spring fingers 503, sets of flanges to be inserted into the EMI spring fingers, and the heating chamber walls of the electronic oven, can have manufacturing tolerances. Attaching or engaging pieces with mismatched mechanical tolerances can lead to plastic deformation, delamination, and seal malfunction. One example manufacturing tolerance can be the amount of out-of-plane deflection a single planar piece, such as those mentioned above, is permitted to have. The out-of-plane deflection scales linearly with the length of the piece, thus the longer the piece, the greater the deflection will be. The introduction of the gaps between sets of EMI spring fingers 503 accommodates these tolerance constraints by limiting the cumulative deflection of the entire set of EMI spring fingers 503 along a heating chamber wall to a number of discretized instances of proportional deflection due to a single EMI spring finger 502. Therefore, having gaps between the sets of EMI spring fingers 503 provides certain benefits over alternative approaches in that it minimizes the effect of manufacturing tolerances on the design.

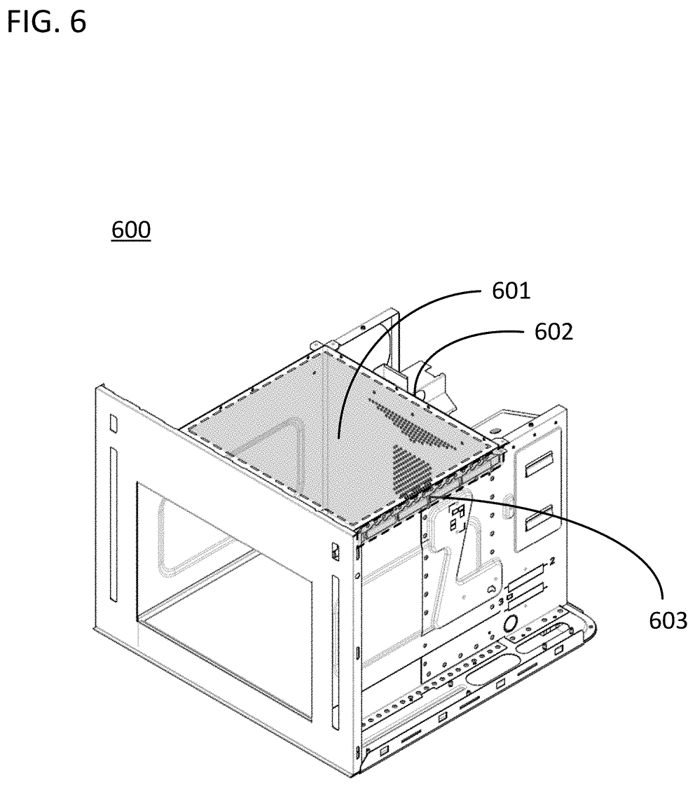

FIG. 6 provides a computer aided design image in an isometric view of a stripped-down electronic oven heating chamber 600 with a module reception opening 601 that comprises a four-edged module reception opening perimeter 602 in accordance with some of the approaches disclosed herein. However, in certain approaches, the module reception opening can have three, or more than four sides. The second means for forming a seal can be attached in the area for attaching the second means for forming a seal 603, along each edge of the module reception opening perimeter 602. In one example, the second means for forming a seal is a set of at least two EMI spring finger segments, wherein the set of at least two EMI spring finger segments includes eight EMI spring finger segments. In another example, at least two EMI spring fingers in the set of at least two EMI spring finger segments are located on each of the four edges of the module reception opening 601. In another example, the second means for forming a seal is a bracket with a screw hole for anchoring the mounting plate of the heating functionality module.

In some embodiments, the second means for forming a seal can be a combination of sets of EMI spring fingers and brackets with screw holes to be mated, respectively, with the first means of forming a seal on the heating functionality module that can be a combination of flanges and brackets with screw holes. In these embodiments, when the module reception opening 601 has four edges along the perimeter 602, two opposing edges can attach the sets of EMI spring fingers and the other two opposing edges can attach the brackets with screw holes. Brackets with screw holes that are fastened by screws can be an advantageous first and second means for forming a seal because they do not have the manufacturing tolerance issues of the sets of EMI spring fingers engaged with flanges.

In some embodiments, the electronic oven heating chamber can undergo a retrofitting process to enable the attachment of a functionality module, wherein the manufacturing tolerance can be set by the accuracy of the process by which the module reception opening 601 is cut or formed. In some embodiments, the manufacturing tolerance can be set by the accuracy of the bending process applied to the sheet metal used to make the electronic oven heating chamber walls.

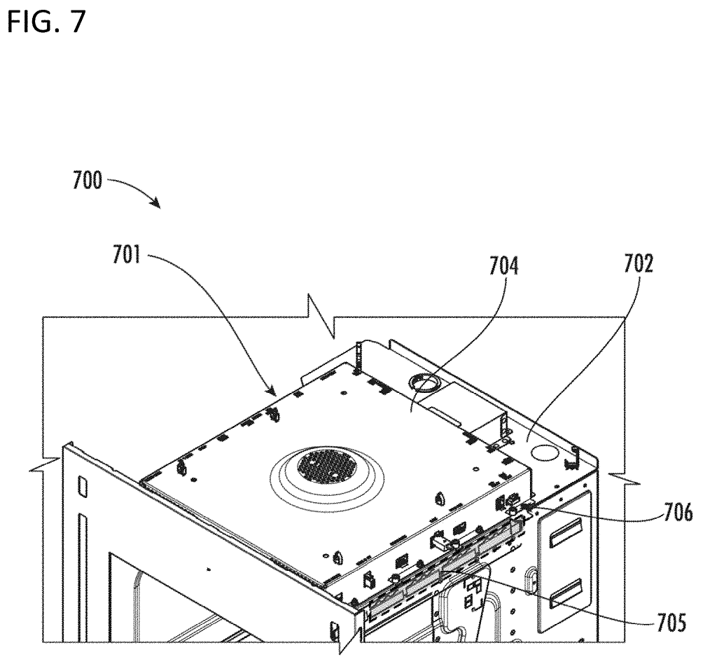

FIG. 7 provides a computer aided design image in isometric view of an electronic oven heating chamber with attached heating functionality module 700 in accordance with some of the approaches disclosed herein. In some approaches, the heating functionality module 701 can have a mounting plate 702, a printed circuit board, and a casing top side element 704. The mounting plate 702 can have four edges and at least a portion of the mounting plate be electrically conductive. In these approaches, the first means for forming a seal can be sets of flanges 705 that project outward from the mounting plate 702 and can engage with sets of at least two EMI spring fingers to form a seal. FIG. 7 shows one such example of the engagement of the sets of flanges 705 with sets of EMI spring fingers to form a seal, wherein the EMI spring fingers partially obscure the sets of flanges 705 from view. In one example, the heating functionality module 701 case can comprise a top side element 704 and a bottom side element to protect the heating functionality module components.

In some approaches, an optional final attach process can be implemented after the first means for forming a seal and the second means for forming a seal have been engaged to form a seal. In one example, the optional final attach can be the attaching of brackets using screws in screw holes 706, located at the corners of the module reception opening perimeter and on the mounting plate 702, by drilling no more than eight screws into the holes. The eight screws can be placed accordingly, with two at each corner of the module reception opening, in embodiments in which the module reception opening has four sides. The number of screws should be kept to a minimum to make the optional final attach efficient. However, the number of screws should also be sufficient to make the seal secure. As such, the number of screws is a function of the length of the seal area needed to be ensured by the screws. In specific embodiments of the invention, the distance between screws is less than 30 millimeters along the path of the seal. In one example, the final attach process can be implemented by spot welding the flanges to the sets of EMI spring fingers to form permanent joints. The welding process and the screw drilling process can be used individually, or in combination, for the optional final attach process. In one example, flanges outwardly protruding from the mounting plate 702 can be engaged with sets of EMI spring fingers along three edges of the opening for module reception and a fourth edge can be spot welded in the final attach process.

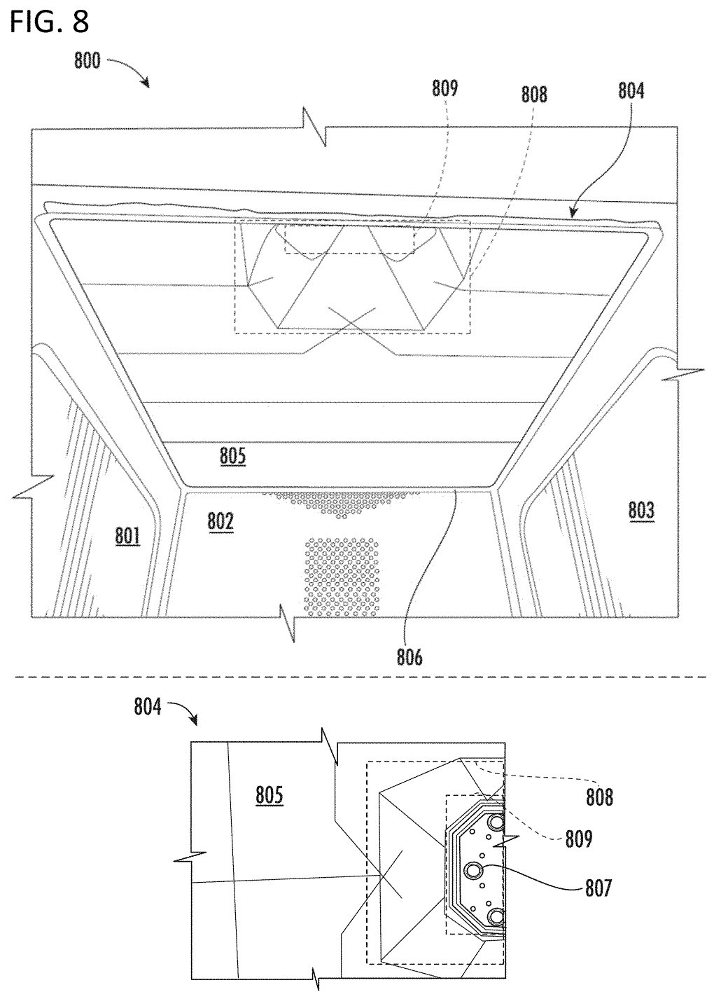

FIG. 8 provides two line drawings of the inside of a prototype electronic oven heating chamber 800 with attached heating functionality module, showing configurations of an integrated splashguard, casing bottom side element 805 and sensor apertures 807 incorporated with the heating chamber ceiling 804, in accordance with some of the approaches disclosed herein. One line drawing captures the view of an example embodiment, looking into the heating chamber from the front side, through where a first opening for an electronic oven door could be placed. The view is tilted at an upward angle, such that the heating chamber left side wall 801, heating chamber back side wall 802, and heating chamber right side wall 803 are visible. The other line drawing captures the view of the same example embodiment, looking directly upward from the center of the heating chamber, at the heating chamber ceiling 804, which can be physically formed by a casing bottom side element 805, or integrated splashguard, of the heating functionality module that is conformal to the inside of the heating chamber 800 and sealed to the heating chamber by the casing bottom side element seal 806.

In some embodiments, the heating functionality module can comprise a casing bottom side element 805 that has at least a portion of the bottom side element that is transparent to RF radiation, at least one energy steering element, an RF energy source, a waveguide connected to the RF energy source, and a terminal end of the waveguide directed towards the portion of the casing bottoms side element, a mounting plate, where the at least one energy steering element and the terminal end of the waveguide are within the volume defined by the bottom side element and the mounting plate. In this example, the energy steering elements and terminal end of the waveguide can be above the casing bottom side element 805 and within the area of the RF radiation transparent portion so that RF energy can transmit from at least one energy steering element and the terminal end of the waveguide into the interior of the heating chamber.

In some embodiments, the heating functionality module can comprise a casing bottom side element 805 that includes at least one aperture 807, a sensor, and a field of view of the sensor via the aperture 807 that includes a portion of the heating chamber 800. In this example, the casing bottom side element 805 can form the view for the aperture 807 through a cut-away region 808 for the aperture 807 and by placing the aperture 807 in the aperture placement region 809. In this configuration, a sensor can be aligned with, face towards, and be placed behind the aperture 807. In certain embodiments, the aperture 807 can be located above an opening to the heating chamber 800 such that it is generally hidden from view when the chamber door is open.

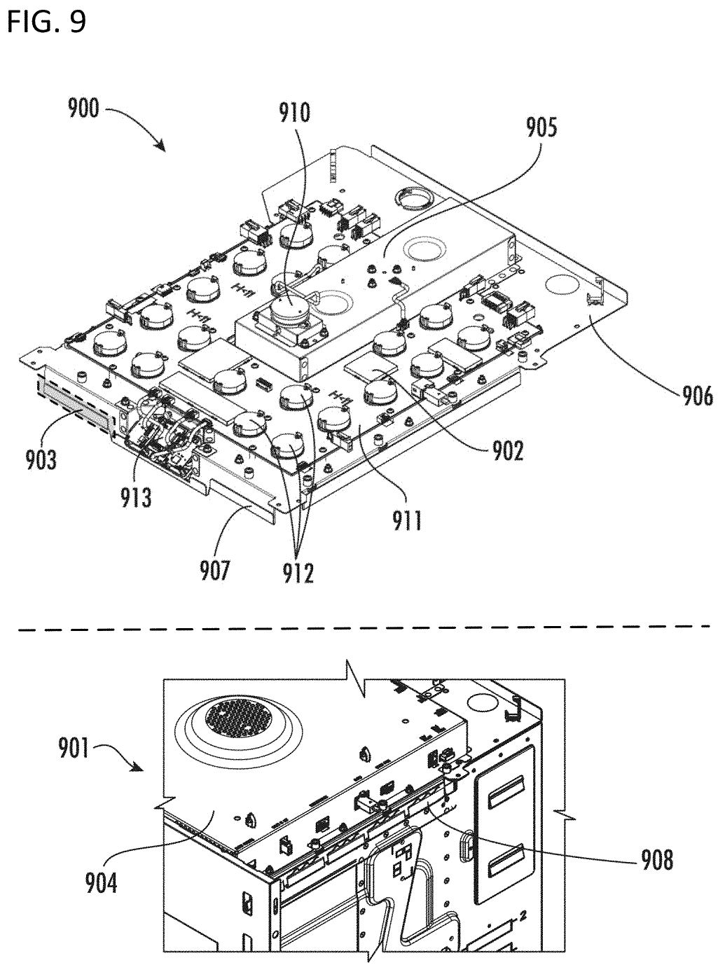

FIG. 9 provides computer aided design images in isometric views of a heating functionality module 900, and a mated heating functionality module and electronic oven 901 in accordance with some of the approaches disclosed herein. In some embodiments, the heating functionality module 900 comprises at least one energy steering element, a microelectronics controller 902 with installed control logic to control energy steering elements, and an area for a first means for forming a seal 903. In some embodiments, the heating functionality module 900 comprises an RF energy source that can generate RF radiation, a waveguide 905 with one end connected to the RF energy source and that can channel the RF radiation, and a controller 902 with at least one integrated circuit that stores instructions to control the RF energy source and at least one energy steering element.

In some embodiments, the heating functionality module 900 comprises a mounting plate 906 wherein at least a portion of the mounting plate 906 is electrically conductive and wherein the first means for forming a seal includes the mounting plate 906 and a set of flanges 907 that project outward from the perimeter of the mounting plate 906. As illustrated, the flanges 907 can be bent from the same material used to form the mounting plate 906 on at least one side. As such, the dimensions of the mounting plate 906 can be larger than the electronic oven opening for the heating functionality module. These approaches exhibit certain benefits in that the bottom side components of the heating functionality module 900 can include components that should not be located within the heating chamber of the electronic oven. As illustrated, the RF energy source can be a bottom side component mounted on the mounting plate 906 towards the upper, right edge. In this RF energy source placement, it would be outside the perimeter set by the flanges 907 extending from the mounting plate 906 and would not end up inside the heating chamber when the heating functionality module 900 is installed. In the same embodiments, the first means for forming a seal can be configured to mate with a set of EMI spring fingers 908 on the electronic oven, for example when the first means for forming a seal comprise an inserted set of flanges when engaged to form the seal. In some embodiments, the heating functionality module 900 comprises a mode stirrer motor 910 in which the at least one energy steering element includes a mode stirrer connected to the mode stirrer motor 910. In some embodiments, the heating functionality module 900 comprises a mounting plate 906, with a printed circuit board 911 attached to the mounting plate 906, and a controller 902 being held on the printed circuit board 911.

In some embodiments, the heating functionality module 900 can comprise an array of at least three electro-mechanical actuators 912, wherein each actuator in the array of at least three actuators 912 independently actuates an energy steering element. In some embodiments, the heating functionality module 900 comprises a sensor 913, an RF energy source, and a controller 902 in which the controller 902 receives sensor data from the sensor 913 and stores instructions to control the RF energy source, and the energy steering elements, based on the sensor data. In some embodiments, the heating functionality module 900 comprises a casing 904 to enclose the controller 902 and the energy steering elements, in which the casing 904 comprises a top side element. In one example, the top side element can be a metal, such as aluminum or steel. In some embodiments, the controller 902 includes a non-transitory, computer readable medium with instructions for instantiating a machine intelligence system. The machine intelligence system can control the array of at least three actuators 912 and mode stirrer motor 910 based on input received from sensor 913.

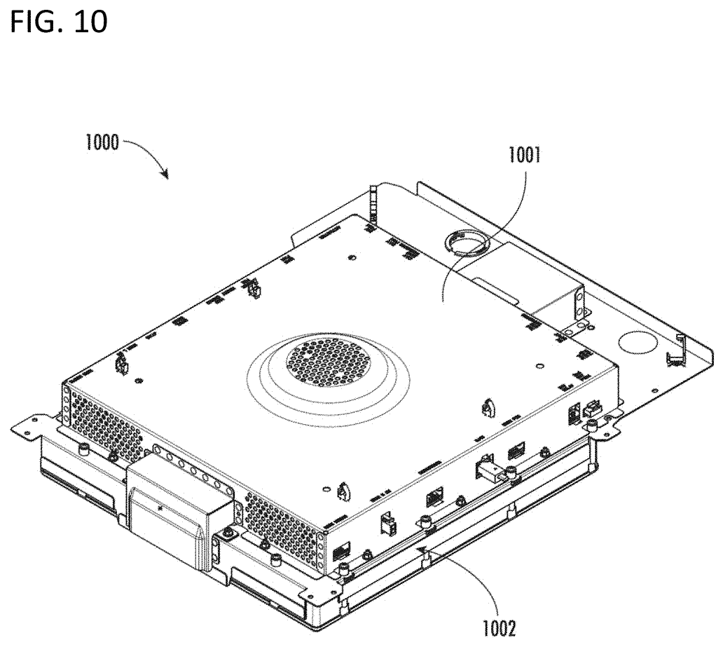

FIG. 10 provides a computer aided design image in an isometric view of a heating functionality module with a casing top side element 1000 in accordance with some of the approaches disclosed herein. In some embodiments, the casing top side element 1001 can be placed above the heating functionality module 1002. In one example, the casing top side element 1001 is plated above components mounted on the heating functionality module 1002. In another example, the casing top side element 1001 can be mounted to the heating functionality module 1002 mounting plate.

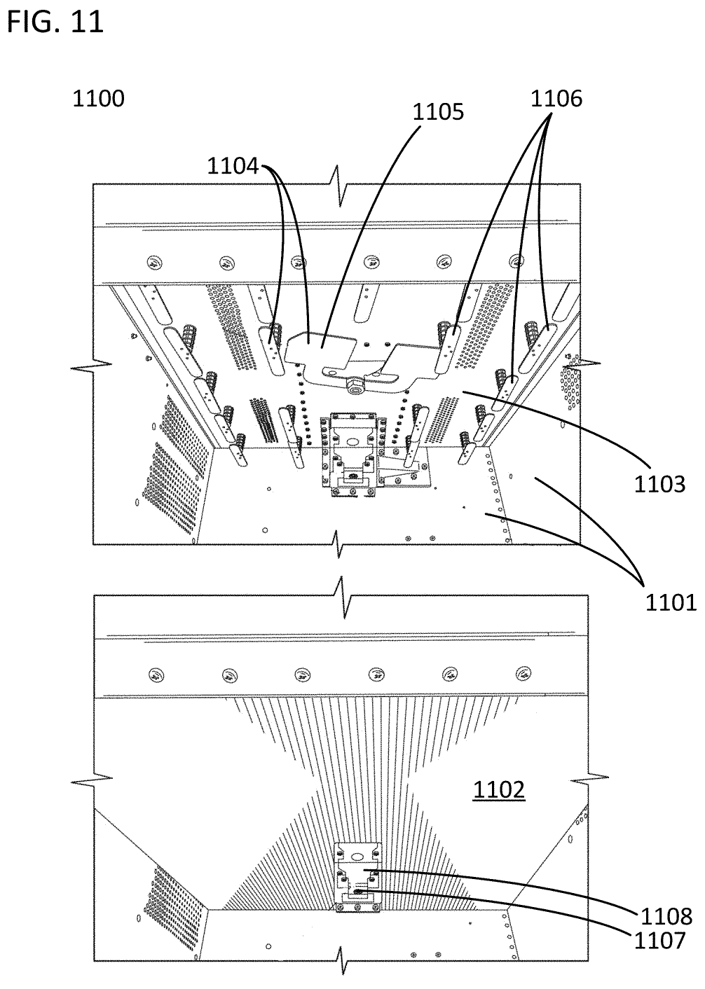

FIG. 11 provides two line drawings of the inside of a prototype electronic oven heating chamber with attached heating functionality module 1100 in accordance with some of the approaches disclosed herein. The drawings capture the view of example embodiments, looking into the heating chamber from the front side, through where a first opening for an electronic oven door could be placed. The view is tilted at an upward angle, such that the heating chamber walls 1101 are visible. In the same view, the heating chamber ceiling is also visible, and in some embodiments can be physically formed by the casing bottom side element 1102 of the heating functionality module. The casing bottom side element 1102 can be conformal to the inside of the heating chamber so that it can cover the entire bottom side of the mounting plate 1103. In one example, at least a portion of the casing bottom side element 1102 can be transparent to RF radiation. In the same view and, if the casing bottom side element 1102 is removed, the heating functionality module bottom side components are shown, which can include energy steering elements 1104, such as a mode stirrer 1105 and an array of at least three reflective elements 1106. In one example, the terminal end of a waveguide can be directed towards the casing bottom side element 1102 from the heating functionality module, in which the terminal end can be adjacent to, overlapping with, or directly over the mode stirrer 1105, if a mode stirrer 1105 is present. In one example, the heating functionality module can include a sensor 1107, that can detect visible light or IR radiation, and an aperture 1108 aligned with the sensor 1107 incorporated with the casing bottom side element 1102.

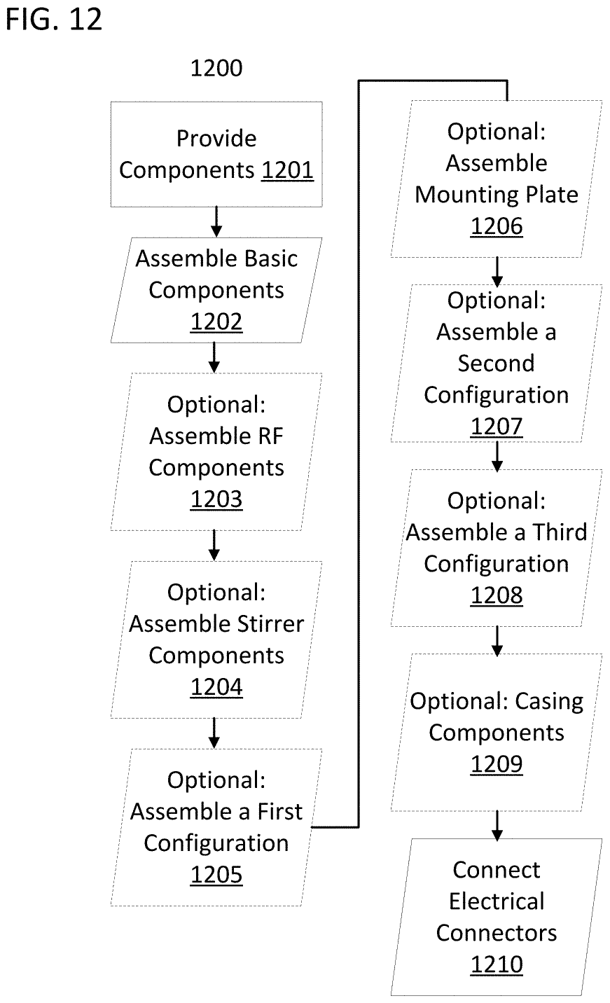

FIG. 12 provides a block diagram and flow chart demonstrating a set of methods 1200 to assemble a heating functionality module that is in accordance with some of the appraoches disclosed herein. In some embodiments, the first method step in the set of methods 1200 can be the providing of heating functionality module components 1201, wherein the components can comprise a mounting plate, a RF energy generator, a waveguide, energy steering elements, a mode stirrer attached to a mode stirrer motor, a printed circuit board, a controller with control logic, a controller comprising at least one integrated circuit, digital memory with instructions, electro-mechanical actuators, a casing comprising a top side element and a bottom side element, and a first means for forming a seal. In these embodiments, the next method step can be the assembly basic design components 1202 comprising at least one energy steering element, the controller with control logic, a first means for forming a seal, and the casing.

In these embodiments, the next method step can be the optional assembling of RF components 1203 comprising an RF energy source, a waveguide connected to the RF energy source in which a terminal end of the waveguide is directed towards the portion of the bottom side element of the casing, and a controller that includes at least one integrated circuit with stored instructions to control the RF energy source and at least one energy steering element. In specific embodiments of the invention, assembling of the RF components 1203 does not involve a waveguide as the RF energy source can be a type of energy source that directly connects to the heating chamber such as a direct ported magnetron. In these embodiments, the next method step can be the optional assembling of stirrer components 1204 comprising a mode stirrer connected to a mode stirrer motor. In these embodiments, the next method step can be the optional assembling of components of a first configuration 1205 comprising a sensor, an RF energy source, and a controller with at least one integrated circuit with stored instructions. In these embodiments, the next method step can be the optional assembling of a mounting plate 1206. In these embodiments, the next method step can be the optional assembling of components of a second configuration 1207 comprising a printed circuit board that can hold a controller and can be directly attached to the mounting plate, in which the top side element is attached to, and covers the top side of, the mounting plate, and the bottom side element is attached to, and covers the bottom side of, the mounting plate. In these embodiments, the next method step can be the optional assembling of components of a third configuration 1208 comprising a mounting plate, an array of at least three actuators, in which at least one energy steering element includes an array of at least three reflective elements, and wherein the array of at least three reflective elements is entirely located between the bottom side element and the mounting plate. In these embodiments, the next method step can be the optional assembling of casing components 1209 comprising the casing top side element attached to the top side of a mounting plate and the casing bottom side element attached to the bottom side of a mounting plate. In these embodiments, the set of methods 1200 can conclude with the inter-connection of components by connecting the components with electrical connectors 1210 to supply electrical power and controlling signals. For example, functionality module could communicate with the control system of the electronic oven using a wired connection provided via USB or a wireless network connection such as a mesh or PAN connection.

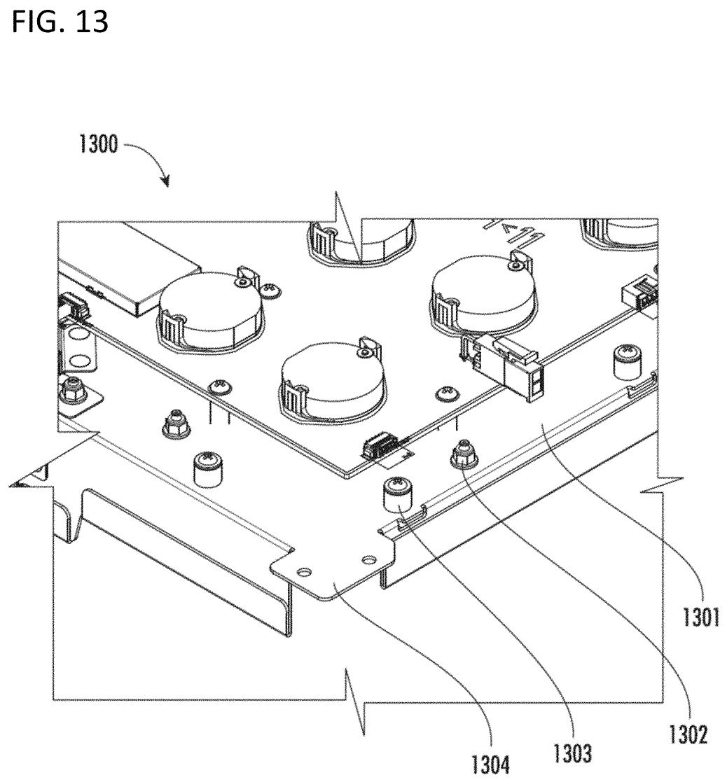

FIG. 13 provides a computer aided design image in an isometric view of a corner portion of the heating functionality module 1300 related to one example attachment of the casing to the mounting plate 1301 in accordance with some of the approaches disclosed herein. In some embodiments, metal posts 1302, such as screws, can be used to attach the casing top side element to the mounting plate 1301, in which the casing top side element covers the top of the mounting plate 1301. In some embodiments, screws can be pushed into standoffs 1303 and further drilled into threaded holes in the casing bottom side element to attach the casing bottom side element to the mounting plate 1301, wherein the casing bottom side element covers the bottom of the mounting plate 1301. In some embodiments, screws can be drilled into threaded holes in a number of final attach elements 1304 on the mounting plate 1301, wherein the screws can be further drilled into threaded holes in the electronic oven to perform a final attach process on the heating functionality module with the electronic oven. In one example of a final attach process, eight or fewer screws are drilled into the final attach elements 1304. The number of screws should also be sufficient to make the seal secure. As such, the number of screws is a function of the length of the seal area needed to be ensured by the screws. In specific embodiments of the invention, the distance between screws is less than 30 millimeters along the path of the seal.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure where generally directed to single heating chamber microwave ovens, the same approaches could be utilized to other types of ovens, such as multiple heating chamber ovens, electronic ovens such as electro-thermal heating element ovens, non-electronic ovens such as natural gas flame ovens, and industrial ovens wherein the items to be heated do not comprise food items. The modules could be installed in an array in large industrial electronic ovens such as those involving conveyor means for moving the items continually through the oven. The modules could then be quickly replaced for repair if any of them were damaged without needing to disrupt the entire heating system. These and other modifications and variations to the present invention may be practiced by those skilled in the art, without departing from the scope of the present invention, which is more particularly set forth in the appended claims.

1. A functionality module for an electronic oven comprising:
at least one energy steering element;
a controller with control logic for the at least one energy steering element;
a first means for forming a seal with an opening in an electronic oven heating chamber; and
a casing to enclose the controller and the at least one energy steering element;
wherein the casing comprises a top side element and a bottom side element; and
wherein the casing and first means for forming a seal are arranged such that, when the first means for forming a seal forms a seal with the opening in the electronic oven heating chamber, the bottom side element resides inside the electronic oven heating chamber and the top side element resides outside the electronic oven heating chamber.

2. The functionality module of claim 1, wherein:
a portion of the bottom side element of the casing is transparent to radio frequency radiation.

3. The functionality module of claim 2, further comprising:
a radio frequency energy source; and
a waveguide connected to the radio frequency energy source, wherein a terminal end of the waveguide is directed towards the portion of the bottom side element of the casing;
wherein the controller: (i) includes at least one integrated circuit; and (ii) stores instructions to control the radio frequency energy source and the at least one energy steering element.

4. The functionality module of claim 1, further comprising:
a mounting plate;
wherein at least a portion of the mounting plate is electrically conductive; and
wherein the first means for forming a seal includes the mounting plate and a set of flanges that project outward from a perimeter of the mounting plate.

5. The functionality module of claim 4, wherein:
the set of flanges of the first means for forming the seal is configured to mate with a set of EMI spring fingers on the electronic oven.

6. The functionality module of claim 1, further comprising:
a mode stirrer motor;
wherein the at least one energy steering element includes a mode stirrer connected to the mode stirrer motor.

7. The functionality module of claim 1, further comprising:
a mounting plate; and
a printed circuit board: (i) holding the controller; and (ii) directly attached to the mounting plate;
wherein the top side element is attached to, and covers a top side of, the mounting plate; and
wherein the bottom side element is attached to, and covers a bottom side of, the mounting plate.

8. The functionality module of claim 1, further comprising:
a mounting plate; and
an array of at least three actuators;
wherein the at least one energy steering element includes an array of at least three reflective elements;
wherein each actuator in the array of at least three actuators independently actuates a reflective element in the array of at least three reflective elements; and
wherein the array of at least three reflective elements is entirely located between the bottom side element and the mounting plate.

9. The functionality module of claim 1, further comprising:
a sensor; and
a radio frequency energy source;
wherein the controller: (i) includes at least one integrated circuit; (ii) receives sensor data from the sensor; and (iii) stores instructions to control the radio frequency energy source and the at least one energy steering element based on the sensor data.

10. The functionality module of claim 9, wherein:
the bottom side element includes an aperture;
the sensor detects one of: (i) visible light; and (ii) infrared radiation; and
the sensor is aligned with the aperture to detect the one of: (i) visible light; and (ii) infrared radiation.

11. An electronic oven comprising:
a functionality module, having: (i) a mounting plate; (ii) a first means for forming a seal; (iii) at least one energy steering element; and (iv) a controller with control logic for the at least one energy steering element;
a heating chamber, having: (i) at least one heating chamber opening; (ii) at least one module reception opening; and (iii) a second means for forming a seal;
a casing to enclose the controller and the at least one energy steering element;
a radio frequency radiation opaque seal, wherein: the seal consists of an engagement between the first means for forming a seal from the functionality module and the second means for forming a seal from the heating chamber;
wherein the casing comprises a top side element and a bottom side element; and
wherein the casing and first and second means for forming a seal are arranged such that the bottom side element resides inside the heating chamber on an interior side of the radio frequency radiation opaque seal, and the top side element resides outside the heating chamber on an exterior side of the radio frequency radiation opaque seal.

12. The electronic oven of claim 11, wherein the second means for forming a seal comprises:
a set of at least two electromagnetic interference (EMI) spring finger segments.

13. The electronic oven of claim 12, wherein the set of at least two EMI spring finger segments are:
attached to an edge of a perimeter of the module reception opening;
adjacent; and
have a spacing gap of less than thirty millimeters measured along the edge.

14. The electronic oven of claim 12, wherein:
the mounting plate has four edges;
at least a portion of the mounting plate is electrically conductive;
the first means for forming a seal includes the mounting plate and a set of flanges that project outward from the mounting plate; and
the engagement is formed by the set of flanges and the set of at least two EMI spring finger segments.

15. The electronic oven of claim 12, wherein:
the module reception opening has four edges;
the set of at least two EMI spring finger segments includes eight EMI spring finger segments; and
at least two EMI spring fingers in the set of at least two EMI spring finger segments are located on each of the four edges of the module reception opening.

16. The electronic oven of claim 12, wherein:
the first means for forming a seal includes the mounting plate and a set of flanges that project outward from the mounting plate;
the set of at least two EMI spring finger segments define a channel configured to mate with the set of flanges; and
the channel has a relaxed channel width of less than 2 millimeters.

17. The electronic oven of claim 16, wherein:
the channel has a channel height of greater than 10 millimeters.

18. The electronic oven of claim 11, wherein the second means for forming a seal is:
attached to at least one edge of a perimeter of the module reception opening;
a bracket; and
a screw hole in the bracket for anchoring the mounting plate of the functionality module.

19. The electronic oven of claim 11, wherein:
the casing encloses the functionality module;
and (ii) the bottom side element is conformal to the module reception opening.

20. The electronic oven of claim 19, wherein:
at least a portion of the bottom side element is transparent to radio frequency radiation;
the functionality module further comprises a radio frequency energy source and a waveguide connected to the radio frequency energy source;
a terminal end of the waveguide is directed towards the portion of the bottom side element; and
the at least one energy steering element and the terminal end of the waveguide are within a volume defined by the bottom side element and the mounting plate.

21. The electronic oven of claim 19, wherein:
the bottom side element includes at least one aperture;
the functionality module has a sensor; and
a field of view of the sensor via the aperture includes a portion of the heating chamber.

22. A method comprising:
providing a functionality module, wherein the functionality module comprises: (i) a mounting plate; (ii) a first means for forming a seal with an opening in an electronic oven heating chamber; (iii) a casing comprising a bottom side element and a top side element; (iv) at least one energy steering element; and (v) a controller with control logic for the at least one energy steering element;
providing an electronic oven, wherein the electronic oven comprises: (i) a heating chamber with a first opening for a heating chamber door, and a second opening for functionality module reception; and (ii) a second means for forming a seal with the functionality module;
engaging the functionality module with the electronic oven heating chamber to form a radio frequency opaque seal between the first means for forming a seal and the second means for forming a seal; and
wherein, after engaging the functionality module with the electronic oven heating chamber, the bottom side element resides inside the heating chamber on an interior side of the radio frequency opaque seal and the top side element resides outside the heating chamber on an exterior side of the radio frequency opaque seal.

23. The method in claim 22, wherein the engaging comprises:
mating a set of flanges that project outward from the mounting plate with a set of electromagnetic interference (EMI) spring fingers.

24. The method in claim 23, wherein the engaging further comprises:
fastening two aligned brackets using a set of mechanical fastening features;
wherein the two aligned brackets are aligned on two opposing edges of the mounting plate.

25. The method in claim 23, wherein:
the second opening for functionality module reception has a set of edges; and
the set of EMI spring fingers include a subset of two EMI spring fingers on each edge of the set of edges.

26. The method in claim 25, wherein:
gaps between adjacent EMI spring fingers in each subset of two EMI spring fingers is less than thirty millimeters.

27. The method in claim 23, further comprising:
spot welding the set of flanges to the electronic oven;
wherein a distal height of the set of EMI spring fingers varies, in a repeating fashion, along a length of the set of EMI spring fingers; and
wherein the spot welding is conducted at points where the distal height of the set of EMI spring fingers is at a local minimum.

28. The method in claim 22, further comprising:
attaching of the bottom side element to the mounting plate to protect functionality module components installed underneath the mounting plate; and
attaching of the top side element to the mounting plate to protect functionality module components installed above the mounting plate.

29. The method in claim 22, further comprising:
removing a portion of a wall of the electronic oven heating chamber to form the second opening, whereby the second opening includes an exposed edge; and
installing the second means for forming a seal on the exposed edge.

30. The method in claim 29, wherein:
the engaging comprises mating a set of flanges that project outward from the mounting plate with a set of electromagnetic interference (EMI) spring fingers; and
the installing comprises attaching the set of EMI spring fingers to the exposed edge.
